(19) United States
(12) Patent Application Publication
(10) Pub. No.: US 2023/0024088 A1
(43) Pub. Date: Jan. 26, 2023

(54) CARGO STABILIZER

(71) Applicant: NISSAN NORTH AMERICA, INC., Franklin, TN (US)

(72) Inventor: Daniel MORALES, Farmington Hills, MI (US)

(73) Assignee: NISSAN NORTH AMERICA, INC.

(21) Appl. No.: 17/381,033

(22) Filed: Jul. 20, 2021

(51) Int. Cl. B60P 7/135

(52) U.S. Cl. CPC B60P 7/135

(57) ABSTRACT

A cargo stabilizer includes a first section and a second section. The first section defines a base for the cargo stabilizer. The second section is spaced from the first section on a same plane as the first section when the cargo stabilizer is in a collapsed state. The second section is layered over the first section when the cargo stabilizer is in an upright state.

### BACKGROUND

### Technical Field

The present disclosure generally relates to a cargo stabilizer. More specifically, the present disclosure relates to a cargo stabilizer for a vehicle's interior storage area.

### Background Information

Cargo stored in a vehicle's storage area can be subject to unwanted movement or shifting when the vehicle is in use. The movement can cause undesired damage to the cargo, and may cause damage to the interior of the vehicle. Therefore, it can be desirable to restrain the cargo from moving or shifting around in the storage during operation of the vehicle.

### SUMMARY

In view of the state of the known technology, one aspect of the present disclosure is to provide a cargo stabilizer comprising a first section and a second section. The first section defines a base for the cargo stabilizer. The second section is spaced from the first section on a same plane as the first section when the cargo stabilizer is in a collapsed state. The second section is layered over the first section when the cargo stabilizer is in an upright state.

### BRIEF DESCRIPTION OF THE DRAWINGS

Referring now to the attached drawings which form a part of this original disclosure:

FIG. 1 is a perspective view of a vehicle's interior storage area that is equipped with cargo stabilizers in accordance with an illustrated embodiment;

FIG. 2 is a perspective view of the vehicle's interior storage area with the cargo stabilizers in a collapsed state;

FIG. 3 is a top perspective view of the cargo stabilizer in the collapsed state;

FIG. 4 is a bottom perspective view of the cargo stabilizer in the collapsed state;

FIG. 5 is a perspective view of the cargo stabilizer in an upright state;

FIG. 6 is a bottom perspective view of the cargo stabilizer in an upright state;

FIG. 7 is a cross-section of a first section of the cargo stabilizer;

FIG. 8 is a cross-section of an enlarged portion of the first section of FIG. 7;

FIG. 9 is a cross section of a second section of the cargo stabilizer;

FIG. 10 is a cross-section of an enlarged portion of the second section of FIG. 9;

FIG. 11 is a cross-section of a third section of the cargo stabilizer;

FIG. 12 is a cross-section of an enlarged portion of the third section of FIG. 11;

FIG. 13 is a cross-section of a fourth section of the cargo stabilizer; and

FIG. 14 is a cross-section of an enlarged portion of the fourth section of FIG. 13.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

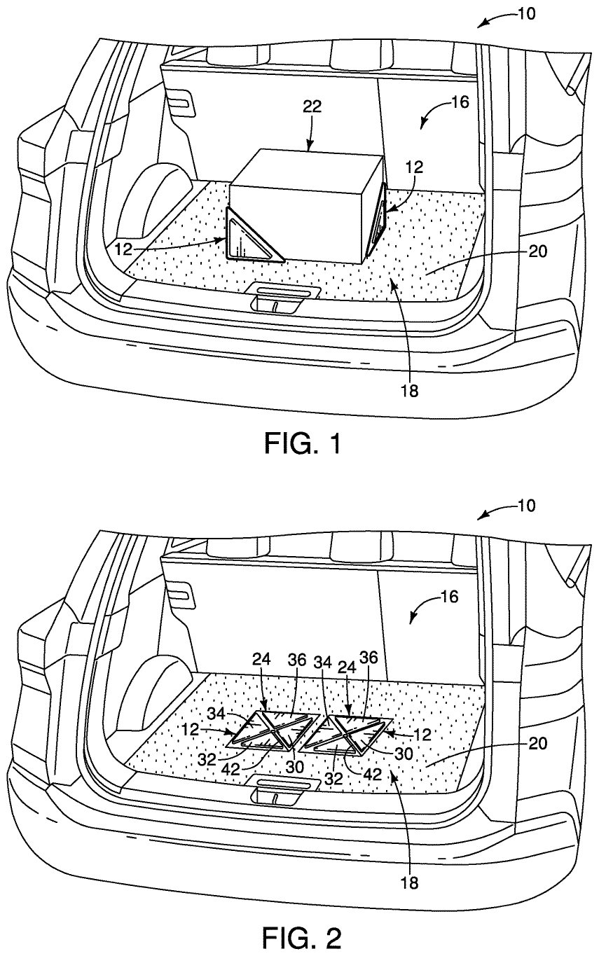

Referring initially to FIG. 1, a portion of a vehicle 10 is illustrated as being equipped with a cargo stabilizer 12 in accordance with an illustrated embodiment. As shown, the vehicle 10 includes a rear hatch (not shown) or a tailgate that at least partially encloses an interior storage area 16 of the vehicle 10. The rear hatch is movable between open and closed positions to enable a user to access the vehicle 10's interior storage area 16. The vehicle 10 includes a carpet 18 that covers a floor of the storage area 16. The carpet 18 is a conventional carpet that preferably has a plurality of loops 20 that can be detachably attached to a portion of the cargo stabilizer 12, as will be further described below.

Conventional cargo stabilizers are typically made of hard durable material, such as hard plastic, in order to retain cargo containers 22 in the storage area 16. Cargo stabilizers that are made of hard plastic or other heavy duty materials are susceptible to breaking off during vehicle use. As shown, the cargo stabilizer 12 is provided in accordance with the illustrated embodiment. The cargo stabilizer 12 is lightweight and can be detachably fixed to the carpet 18 in order to retain the cargo stabilizer 12 in place when the cargo stabilizer 12 is in use. The cargo stabilizer 12 can also be collapsible into a flat configuration when the cargo stabilizer 12 is not in use, as shown in FIG. 2.

Therefore, the cargo stabilizer 12 of the illustrated embodiment is movable between an upright state (FIG. 1) and a collapsed state (FIG. 2). The cargo stabilizer 12 can retain cargo in the upright state, and is stowed in the collapsed state. The cargo stabilizer 12 functions as a cargo liner or a retention device for various types of cargo containers 22 such as boxes or baskets to secure cargo in the storage area 16 of the vehicle 10. In the illustrated embodiment, the cargo stabilizer 12 is primarily made of fabric with rigid layers that are inserts stored inside pockets of the fabric, as will be further discussed.

As shown, a pair of cargo stabilizers 12 are provided to retain the cargo container 22, such as a box. That is, each of the cargo stabilizers 12 abut a corner of the cargo container 22. In use, the cargo stabilizers 12 preferably abut a pair of opposing corners of the cargo container 22. It will be apparent to those skilled in the vehicle field from this disclosure that the vehicle 10 can be provided with additional cargo stabilizers 12 to retain all the corners of the cargo container 22 if desired. As the cargo stabilizers 12 are identical with respect to each other, only one of the cargo stabilizers 12 will be further described for herein.

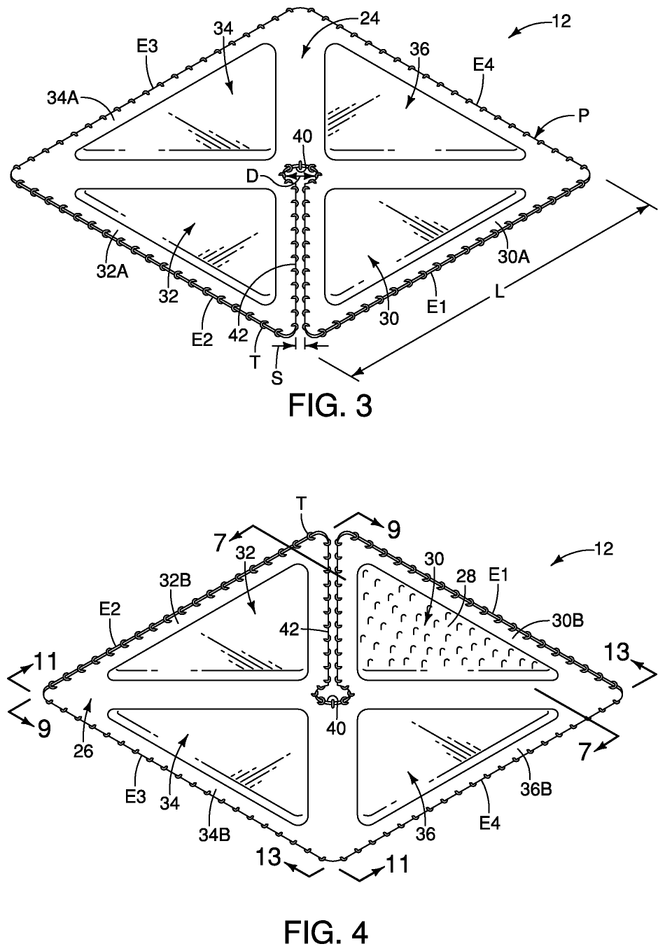

Referring to FIGS. 3 and 4, the cargo stabilizer 12 has an upper surface 24 (FIG. 3) and an underside surface 26 (FIG. 4). The underside surface 26 faces the carpet 18 when the cargo stabilizer 12 is in the collapsed state. The upper surface 24 faces away from the carpet 18 when the cargo stabilizer 12 is in the collapsed state. The upper surface 24 forms an interior surface of the cargo stabilizer 12 that abuts the cargo container 22 when the cargo stabilizer 12 is the upright state. The upper surface 24 and the underside surface 26 are both fabric surfaces.

For example, the upper surface 24 can include denim or vinyl. In the illustrated embodiment, the upper and underside surfaces 24 and 26 at least partially include denim or vinyl or both. In particular, the underside surface 26 further includes one of a hooks layer 28 and a loops layer. Preferably, the underside surface 26 includes a hooks layer 28 that will fasten to the loops 20 of the carpet 18. It will be apparent to those skilled in the vehicle field from this disclosure that upper surface 24 and the underside surface 26 can include additional or alternative types of fabric material as needed and/or desired.

In the illustrated embodiment, the cargo stabilizer 12 comprises a first section 30 and a second section 32. The cargo stabilizer 12 further comprises a third section 34 and a fourth section 36. Each of the first, second, third and fourth sections 30, 32, 34 and 36 define a quarter portion of the cargo stabilizer 12. Each of the first, second, third and fourth sections 30, 32, 34 and 36 have a triangular shape and together form the cargo stabilizer 12 that has a substantially square-like outer perimeter P. The first section 30 includes a first side edge E1 of the cargo stabilizer 12. The second section 32 includes a second side edge E2 of the cargo stabilizer 12. The third section 34 includes a third side edge E3 of the cargo stabilizer 12. The fourth section 36 includes a fourth side edge E4 of the cargo stabilizer 12. The first, second, third and fourth side edges E1, E2, E3 and E4 define the outer perimeter P of the cargo stabilizer 12.

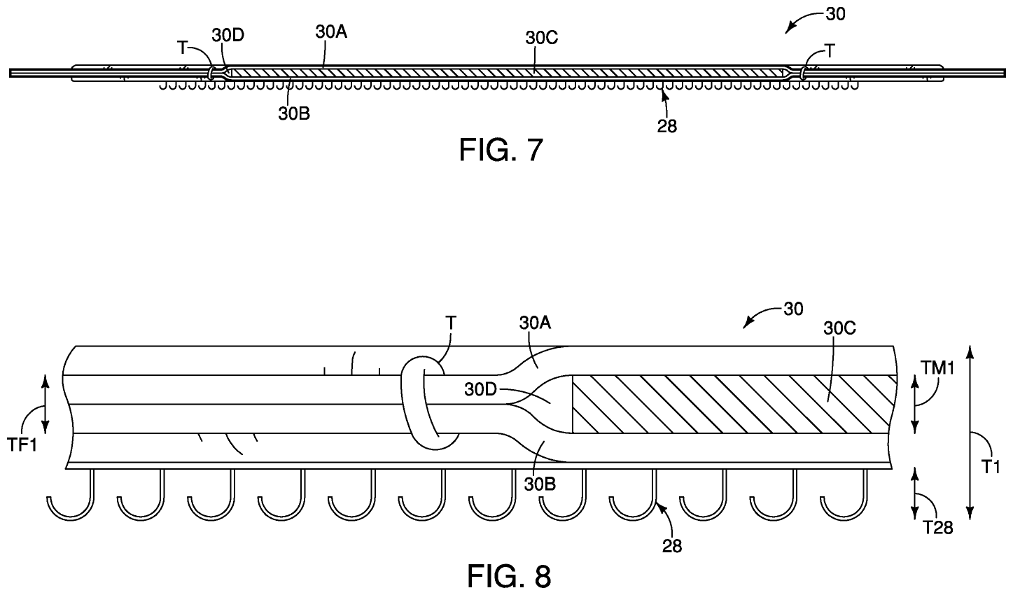

Referring to FIGS. 7 to 10, the first section 30 includes a first top fabric layer 30A and a first bottom fabric layer 30B. The second section 32 includes a second top fabric layer 32A and a second bottom fabric layer 32B. The third section 34 includes a third top fabric layer 34A and a third bottom fabric layer 34B. The fourth section 36 includes a fourth top fabric layer 36A and a fourth bottom fabric layer 36B. In the illustrated embodiment, the first, second, third and fourth top fabric layers 30A, 32A, 34A and 36A are integrally connected. In the illustrated embodiment, the first, second, third and fourth bottom fabric layers 30B, 32B, 34B and 36B are also integrally connected.

The upper surface 24 of the cargo stabilizer 12 is formed by the first, second, third and fourth top fabric layers 30A, 32A, 34A and 36A. The underside surface 26 of the cargo stabilizer 12 is formed by the first, second, third and fourth bottom fabric layers 30B, 32B, 34B and 36B. In particular, the first, second, third and fourth top fabric layers 30A, 32A, 34A and 36A are preferably made of a single layer of vinyl or denim fabric that is separated into the first, second, third and fourth sections 30, 32, 34 and 36 by stitching T. Similarly, the first, second, third and fourth bottom fabric layers 30B, 32B, 34B and 36B are also preferably made of a single layer of vinyl or denim fabric that is separated into the first, second, third and fourth sections 30, 32, 34 and 36 by stitching T.

As shown in FIGS. 3 and 4, the cargo stabilizer 12 has a center cutout 40 that is connected to a slit 42 that separates the first and second sections 30 and 32. The center cutout 40 and the slit 42 enable the first and second sections 30 and 32 to be layered with respect to each other when the cargo stabilizer 12 is in the upright position. In the illustrated embodiment, each of the first, second, third and fourth side edges E1, E2, E3 and E4 preferably has a maximum length L that is approximately ten (10) times a diameter D of the center cutout 40. That is, the diameter D of the center cutout 40 is approximately one-tenth ( 1/10) the maximum length L of any one of the first, second, third and fourth side edges E1, E2, E3 and E4.

For example, in the illustrated embodiment, each of the first, second, third and fourth side edges E1, E2, E3 and E4 preferably has a maximum length L of approximately two hundred (200) millimeters (mm). The diameter D of the center cutout 40 is preferably approximately twenty (20) millimeters. It will be apparent to those skilled in the vehicle field from this disclosure that the dimensions of the side edges E1, E2, E3 and E4 and the center cutout 40 can vary while maintaining the approximate ratio of the maximum length L of the side edges E1, E2, E3 and E4 to the diameter D of the center cutout 40.

The slit 42 extends from the center cutout 40 towards a corner of the cargo stabilizer 12 to separate the first and second sections 30 and 32. The slit 42 is approximately two (2) mm across. That is, the first and second sections 30 and 32 are separated by a space S of approximately 2 mm. However, it will be apparent to those skilled in the vehicle field from this disclosure that the first and second sections 30 and 32 can be separated by a slit of different distances as long as the first and second sections 30 and 32 can be folded to layer over one another.

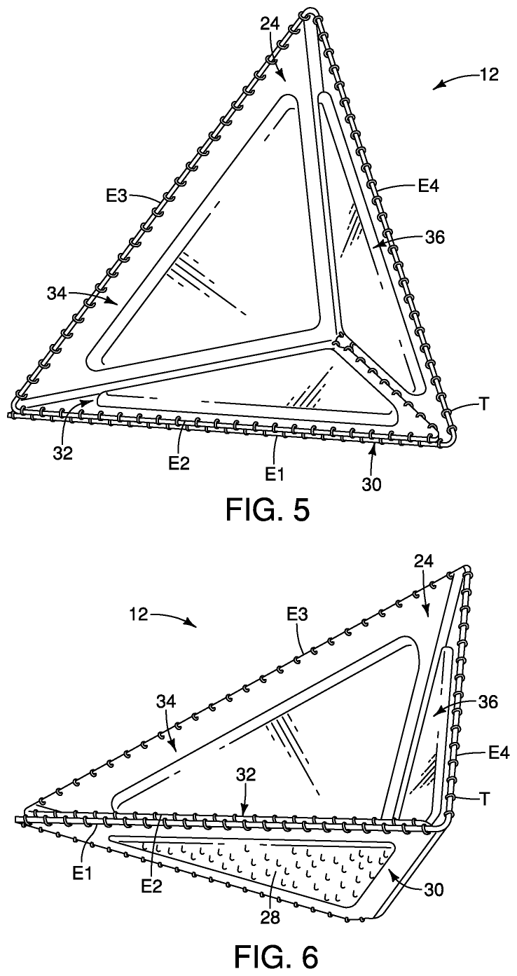

As seen in FIGS. 5 and 6, the first section 30 defines a base for the cargo stabilizer 12. The second section 32 is spaced from the first section 30 on a same plane as the first section 30 when the cargo stabilizer 12 is in a collapsed state. The second section 32 is layered over the first section 30 when the cargo stabilizer 12 is in the upright state. The third section 34 is connected to the second section 32. In particular, the second and third sections 32 and 34 are integrally connected by fabric. The fourth section 36 is connected to the first section 30 and the third section 34. In particular, the third and fourth sections 34 and 36 are integrally connected by fabric.

The third and fourth sections 34 and 36 stand upright to form an open pyramid configuration with the first and second sections 30 and 32 when the cargo stabilizer 12 is the upright state. Therefore, the third and fourth sections 34 and 36 are upright with respect to the first and second sections 30 and 32 when the cargo stabilizer 12 is in the upright state. The third and fourth sections 34 and 36 are on the same plane as the first and second sections 30 and 32 when the cargo stabilizer 12 is in the collapsed state. In the upright state, the cargo container 22 can sit on the first and second sections 30 and 32. The third and fourth sections 34 and 36 are raised to abut the sides of the cargo container 22 when the cargo stabilizer 12 is in the upright state. The first section 30 detachably attaches to the carpet 18, as will be explained.

As seen in FIGS. 5 and 6, the first section 30 defines a base layer or a floor panel when the cargo stabilizer 12 is in the upright state. Referring to FIGS. 7 and 8, the first section 30 includes a first metal layer 30C. As stated, the first section 30 includes the first top fabric layer 30A and the first bottom fabric layer 30B. The first top fabric layer 30A and the first bottom fabric layer 30B each have a thickness TF1 of approximately one (1) mm. The first top fabric layer 30A and the first bottom fabric layer 30B are stitched together to define a first pocket 30D therebetween. The first metal layer 30C is disposed inside the first pocket 30D and secured therein by the stitching T. That is, the first pocket 30D is stitched with the first metal layer 30C inside. In the illustrated embodiment, the first metal layer 30C has a thickness TM1 of approximately two (2) mm.

The first section 30 further includes the hooks layer 28 that attaches to the loops 20 of the carpet 18. It will be apparent to those skilled in the vehicle field from this disclosure that the first section 30 can alternatively include a loops layer (e.g., loops 20) if the carpet 18 is made of hooks. Therefore, the first section 30 includes one of the hooks layer 28 and the loops layer (e.g., loops 20) in order to detachably attach to the carpet 18 in order to retain the cargo stabilizer 12 in place. The hooks layer 28 is adhered to the first bottom fabric layer 30B to form part of the underside surface 26. For example, the hooks layer 28 can be attached to the first bottom fabric layer 30B by adhesive. Alternatively, the hooks layer 28 can be stitched to the first bottom fabric layer 30B. In the illustrated embodiment, the hooks layer 28 has a thickness T28 of approximately two (2) mm, as seen in FIG. 8. A total thickness T1 of the first section 30 is approximately six (6) mm.

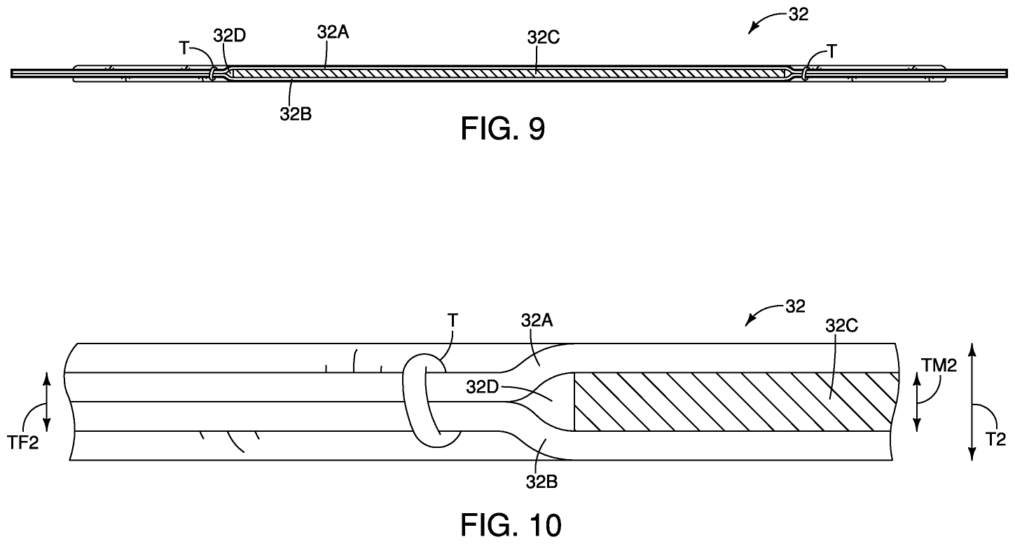

Referring to FIGS. 9 and 10, the second section 32 includes a second metal layer 32C. As stated, the second section 32 further includes the second top fabric layer 32A and the second bottom fabric layer 32B that are stitched together to define a second pocket 32D therebetween. The second metal layer 32C is disposed inside the second pocket 32D and secured therein by the stitching T. That is, the second pocket 32D is stitched with the second metal layer 32C inside. In the illustrated embodiment, the second metal layer 32C has a thickness TM2 of approximately two (2) mm, as seen in FIG. 10. The second top fabric layer 32A and the second bottom fabric layer 32B each have a thickness TF2 of approximately one (1) mm. A total thickness T2 of the second section 32 is approximately four (4) mm.

The first and second metal layers 30C and 32C magnetically engage each other when the second section 32 is layered over the first section 30, as seen in FIGS. 5 and 6. Therefore, the first and second metal layers 30C and 32C have oppositely facing poles when the second section 32 is stacked over the first section 30. In this way, the first and second sections 30 and 32 are magnetically retained to each other to help sustain the cargo stabilizer 12 in the upright state.

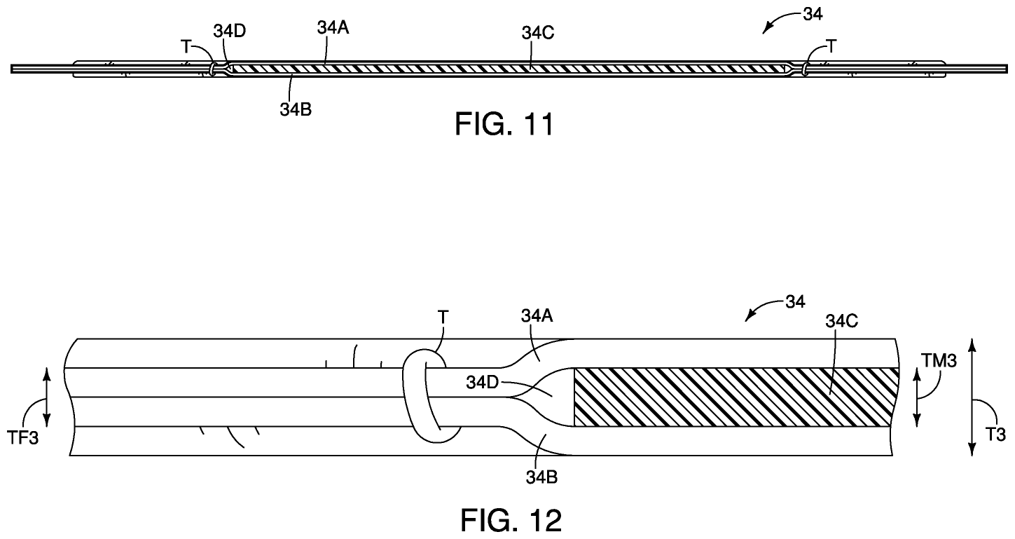

Referring to FIGS. 11 and 12, the third section 34 includes a first rigid layer 34C. As stated, the third section 34 further includes the third top fabric layer 34A and the third bottom fabric layer 34B stitched together to define a third pocket 34D therebetween. The first rigid layer 34C is disposed inside the third pocket 34D. In the illustrated embodiment, the first rigid layer 34C is preferably a plastic insert. Therefore, the first rigid layer 34C is made of plastic. The first rigid layer 34C creates a stiffness for the third section 34 that enables the third section 34 to stand upright in the upright state.

Preferably, the third section 34 stands at approximately at a right angle with respect to the first and second sections 30 and 32 when the cargo stabilizer 12 is in the upright state. In the illustrated embodiment, the first rigid layer 34C has a thickness TM3 of approximately one to two (1-2) mm, as seen in FIG. 12. The third top fabric layer 34A and the third bottom fabric layer 34B each have a TF3 thickness of approximately one (1) mm. A total thickness T3 of the third section 34 is approximately three to four (3-4) mm.

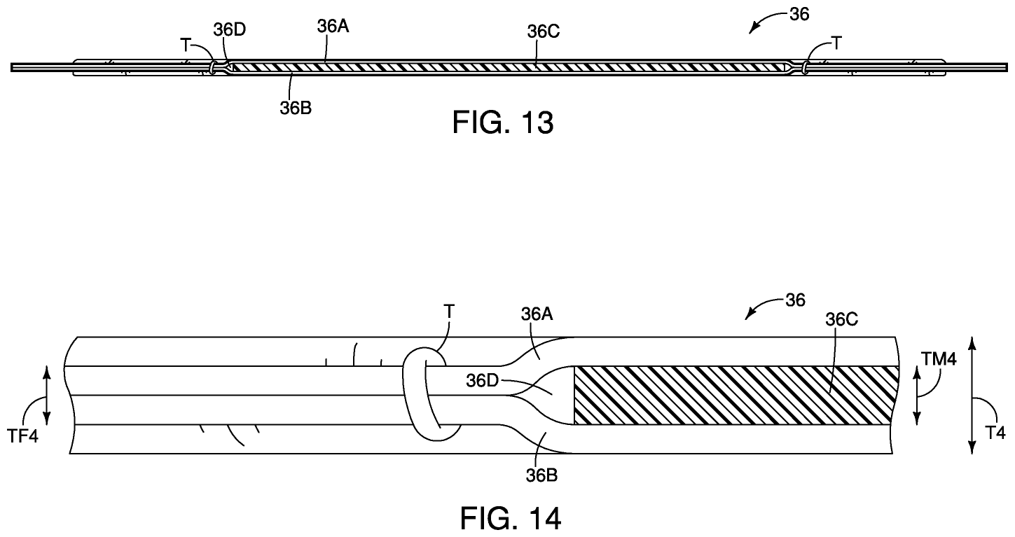

Referring to FIGS. 13 and 14, the fourth section 36 includes a second rigid layer 36C. As stated, the fourth section 36 further includes the fourth top fabric layer 36A and the fourth bottom fabric layer 36B stitched together to define a fourth pocket 36D therebetween. The second rigid layer 36C is disposed inside the fourth pocket 36D. In the illustrated embodiment, the second rigid layer 36C is preferably a plastic insert. Therefore, the second rigid layer 36C is made of plastic. The second rigid layer 36C creates a stiffness for the fourth section 36 that enables the fourth section 36 to stand upright in the upright state.

Preferably, the fourth section 36 stands at approximately at a right angle with respect to the first and second sections 30 and 32 when the cargo stabilizer 12 is in the upright state. In the illustrated embodiment, the second rigid layer 36C has a thickness TM4 of approximately one to two (1-2) mm, as seen in FIG. 14. The fourth top fabric layer 36A and the fourth bottom fabric layer 36B each have a thickness TF4 of approximately one (1) mm. A total thickness T4 of the fourth section 36 is approximately three to four (3-4) mm.

In understanding the scope of the present invention, the term “comprising” and its derivatives, as used herein, are intended to be open ended terms that specify the presence of the stated features, elements, components and/or groups, but do not exclude the presence of other unstated features, elements, components and/or groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the cargo stabilizer. Accordingly, these terms, as utilized to describe the present invention should be interpreted relative to a vehicle equipped with the cargo stabilizer.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A cargo stabilizer comprising:
a first section that defines a base for the cargo stabilizer; and
a second section that is spaced from the first section on a same plane as the first section when the cargo stabilizer is in a collapsed state, the second section being layered over the first section when the cargo stabilizer is in an upright state.

2. The cargo stabilizer according to claim 1, further comprising
a third section that is connected to the second section, and
a fourth section that is connected to the first section and the third section, the third and fourth sections being on the same plane as the first and second sections when the cargo stabilizer is in the collapsed state, the third and fourth sections being upright with respect to the first and second sections when the cargo stabilizer is in the upright state.

3. The cargo stabilizer according to claim 2, wherein
the second and third connections are integrally connected by fabric.

4. The cargo stabilizer according to claim 3, wherein
the fourth and first sections are integrally connected by fabric.

5. The cargo stabilizer according to claim 4, wherein
the third and fourth sections are integrally connected by fabric.

6. The cargo stabilizer according to claim 2, wherein
the first section includes a first metal layer.

7. The cargo stabilizer according to claim 6, wherein
the first section further includes one of a hooks layer and a loops layer.

8. The cargo stabilizer according to claim 7, wherein
the first section includes an top fabric layer and a bottom fabric layer defining a first pocket therebetween, the first metal layer being disposed inside the first pocket.

9. The cargo stabilizer according to claim 8, wherein
the one of the hooks layer and the loops layer is adhered to the bottom fabric layer to form an outer underside layer of the first section.

10. The cargo stabilizer according to claim 9, wherein
the second section includes a second metal layer.

11. The cargo stabilizer according to claim 10, wherein
the second section further includes an top fabric layer and a bottom fabric layer defining a second pocket therebetween, the second metal layer being disposed inside the second pocket.

12. The cargo stabilizer according to claim 11, wherein
the third section includes a first rigid layer.

13. The cargo stabilizer according to claim 12, wherein
the third section further includes an top fabric layer and a bottom fabric layer defining a third pocket therebetween, the first rigid layer being disposed inside the third pocket.

14. The cargo stabilizer according to claim 13, wherein
the first rigid layer is a plastic insert.

15. The cargo stabilizer according to claim 13, wherein
the fourth section includes a second rigid layer.

16. The cargo stabilizer according to claim 15, wherein
the fourth section further includes an top fabric layer and a bottom fabric layer defining a fourth pocket therebetween, the second rigid layer being disposed inside the fourth pocket.

17. The cargo stabilizer according to claim 16, wherein
the second rigid layer is another plastic insert.

18. The cargo stabilizer according to claim 16, wherein
the top fabric layers of the first, second, third and fourth sections are integrally connected.

19. The cargo stabilizer according to claim 18, wherein
the bottom fabric layers of the first, second, third and fourth sections are integrally connected.
